(19) United States
(12) Patent Application Publication
(10) Pub. No.: US 2010/0094550 A1
(43) Pub. Date: Apr. 15, 2010

(54) User interface for dynamic user-defined stopovers during guided naviation ('side trips")

(76) Inventors: Kevin Tsurutome, San Franciso, CA (US); Darrell Sano, Oakland, CA (US); Regan Gill, Berkeley, CA (US)

Correspondence Address: MANELLI DENISON & SELTER PLLC, 7th Floor,, 2000 M Street N.W., Washington, DC, 20036-3307, US

(21) Appl. No.: 12/588,146

(22) Filed: Oct. 6, 2009

Related U.S. Application Data
(60) Provisional application No. 61/136,826, filed on Oct. 7, 2008.

(51) Int. Cl. G01C 21/36; H04W 4/00

(52) U.S. Cl. 701/209; 701/200; 455/456.1

(57) ABSTRACT

A navigation device includes a route determiner module to formulate a first route from a first geographic location to a second geographic location. A route presentation module presents the first route to a user of the navigation device. A side trip presentation module presents a point-of-interest to the user of said navigation device and formulates a second route to said point-of-interest. An options module presents an option, during presentation of the first route, to recalculate the first route to the second geographic location to comprise the second route.

The present application claims priority from U.S. Provisional Application 61/136,826 to Gill et al. entitled “USER INTERFACE FOR DYNAMIC USER-DEFINED STOPOVERS DURING GUIDED NAVIGATION (“SIDE TRIPS”)”, filed Oct. 7, 2008, the entirety of which is expressly incorporated herein by reference.

### BACKGROUND OF THE INVENTION

1. Field of the Invention

This invention relates generally to guided navigation. More particularly, it relates to an improved, guided navigational system for automobiles and other vehicles.

2. Background of the Related Art

Certain modes of travel lend themselves to exploration and intentional diversion from a planned path. In most cases when this occurs, the action is random and unplanned, perhaps based on a glimpse of a passing sign or storefront. But using a conventional vehicle guidance system once something of interest has passed, the user will not be guided back since the moment to decide and act would have already passed.

An attempt to locate specific places of interest while driving is particularly challenging and hazardous. Most navigation products force the user to initiate a point-of-interest (POI) search for one POI at a time, parse the results if the driver veers off the guided course, and once back on the trip, the current route to the POI is altered as necessary. If this activity transpires while driving, there is simply too much cognitive load for the driver.

Personal interests vary widely, and a single, generic POI database requiring repetitive searching, viewing of results, and choosing a result if too distracting is at times too cumbersome and hard to use in certain circumstances, and may even be hazardous.

There is a need for more flexible guided routing equipment.

### SUMMARY OF THE INVENTION

In accordance with the principles of the present invention, a navigation device comprises a route determiner module to formulate a first route from a first geographic location to a second geographic location. A route presentation module presents the first route to a user of the navigation device. A side trip presentation module presents a point-of-interest to the user of the navigation device and formulates a second route to the point-of-interest. An options module presents an option, during presentation of the first route, to recalculate the first route to the second geographic location to comprise the second route.

A method of formulating side trips for a navigation device in accordance with another aspect of the invention comprises formulating, with a route determiner module, a first route from a first geographic location to a second geographic location and presenting, with a route presentation module, the first route to a user of the navigation device. A side trip module presents a point-of-interest to a user of the navigation device and formulates a second route to the point-of-interest. The method further includes providing an option, during the presentation of the first route with an options module, to the user of the navigation device, to recalculate the first route to the second geographic location to comprise the second route.

In another aspect, an apparatus for formulating side trips for a navigation device comprises a means for formulating a first route from a first geographic location to a second geographic location and a means for presenting the first route to a user of the navigation device. A means for presenting is used to present a point-of-interest to a user of the navigation device. A means for formulating is used to formulate a second route to the point-of-interest and a means for providing an option, during the presentation of the first route, to the user of the navigation device is used to recalculate the first route to the second geographic location to comprise the second route.

### BRIEF DESCRIPTION OF THE DRAWINGS

FIG. 1 illustrates a navigation system that provides side trips, in accordance with the principles of the present invention.

FIG. 2 illustrates a detailed view of a navigation server, in accordance with the principles of the present invention.

FIG. 3 illustrates a side trips angle of inclusion, in accordance with the principles of the present invention.

FIGS. 4(A) and 4(B) illustrate a selection of a user defined POI for side trips, in accordance with the principles of the present invention.

FIGS. 5(A)-5(D) illustrate selection of a side trip during guided navigation, in accordance with the principles of the present invention.

FIG. 6 illustrates a process of route guidance to a POI, in accordance with the principles of the present invention.

### DETAILED DESCRIPTION OF ILLUSTRATIVE EMBODIMENTS

In accordance with the principles disclosed herein, a navigation system is provided that on any given route, prompts a user for one or more potential side trip(s) on a way to a destination. Preferably, the user selects with a single click as in the disclosed embodiments.

The navigation system prompts the user to personally select categories of POIs, commercial store brands, etc., that they feel are worthy of a stop over. If the navigated route brings the user to within a given distance (preferably configurable by the user) of selected targets of a side trip, the navigational system informs the user of such and prompts them to include the side trip in the navigated route (or not). In accordance with the invention, a side trip (or multiple side trips) are prompted to the user, with the display of a ChannelHUD or graphic user interface (GUI) that provides a pick list of a point (or points) that a user has expressed an interest in visiting.

The invention provides greater granularity as compared to conventional navigational systems, and presents the ability to select guidance to peripheral locations along a route, or “side trips”, that are highly relevant and desired by the user.

After selection, but during navigation, side targets, or side POI(s) that are relevant and match a user's interest are preferably verbally called out well before reaching them, providing ample decision making time for the user to pursue such a “side trip”.

Preferably, only one side trip is explicated at a time, and if no action is taken by the user, the explicated side trip simply “dissolves” off the map. On the other hand, if the user decides to pursue the side trip, the application preferably generates a new route that includes the side trip at some point between the current location and the final destination.

The inventive navigation system incorporates traveling information such as speed, distance to the side POI, and if the side POI resides within a reasonable angle of inclusion, when determining any potential side trip(s) for selection by the user. Navigation prompts take precedence and are preferably never interrupted with side trip queries. Therefore, side trip prompts are not explicated unless there is ample minimum time before and after explication without cut-off by the otherwise conventional navigation explication.

If two or more side trips are near the current route, preferably one side trip is given precedence over the other(s). For instance, in disclosed embodiments, preferably only the closest side trip to the route is explicated. Thus, in such an embodiment, a side trip POI closest to a current route preferably takes precedence if there are several side trip targets that are too close to each other.

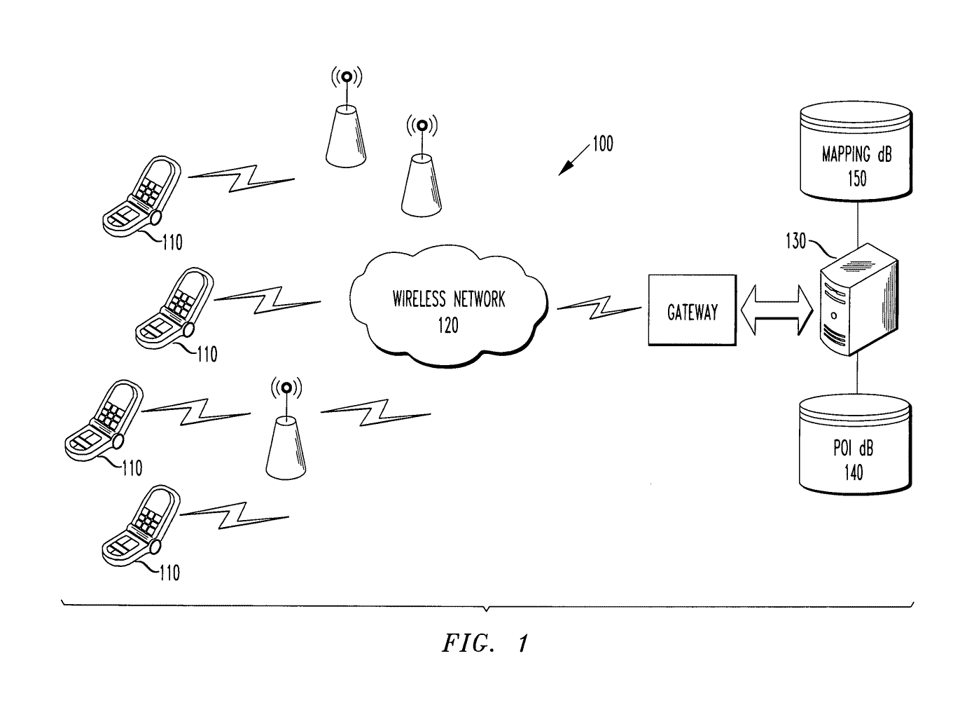

FIG. 1 illustrates a navigation system that provides side trips, in accordance with the principles of the present invention.

In disclosed embodiments, the navigation system 100 is implemented within a suitable a wireless device 110 (e.g., a smart phone), and is supported over a wireless network 120 (e.g., the Internet). The navigation system 100 may alternatively be a stand-alone system such as one that is integrated within an automobile assembled with a navigation option. Wireless device 110 can access navigation server 130 through either a public or private Internet Protocol (IP) address.

In accordance with the principles disclosed herein, the navigation system 100 provides a side trips retrieval system using a navigation server 130, a mapping database 150, and a point-of-interest database 140. The navigation server 130, mapping database 150, and/or POI database 140 are located within a service provider's network, though they may alternatively be provided by a third party outside of the service provider's network. Navigation server 130 can support navigation functions provided by TeleCommunication System, Inc.'s TCS Navigator, Verizon's VZ Navigator^{SM}, etc., with the principles disclosed herein being a possible improvement to such navigation services.

The wireless device 110, including the inventive navigation system 100, allows a user, through an appropriate graphical user interface (GUI), to enter a destination. A starting point may also be entered if routing is desired between a location that the user will be at in the future, and the destination. The wireless device 110 may also alternatively make use of location information obtained from a carrier's network, or even from a local global positioning system (GPS) either within the wireless device 110 or connected thereto. Thus, the wireless device 110 may provide a user with the option to select their current geographic location as the beginning geographic location.

Geographic locations can be entered as an address, a locality, a landmark, a point represented by a cursor on a display screen superimposed over a map, etc. In accordance with a TCS Navigator implementation, entry of such information can additionally be made through voice recognition.

The navigation system 100 transmits the beginning geographic location and the destination to the navigation server 130, e.g., over the Internet. The navigation server 130 provides a route, as well as mapping display tiles appropriate for display on the relevant wireless device 110.

Importantly, the navigation system 100 of the wireless device 110 prompts a user, through an appropriate GUI, the option to select POI(s). The selection may be as a category or other suitable search criteria for a POI.

Using a route calculated from a starting point to the destination using user criteria (e.g., no ferries, no highways, etc.), potential side trip POIs are determined and obtained by the navigation server 130. The navigation system 100 of the wireless device 110 downloads map tiles, POI data, and side trip routing to POI(s) from the navigation server 130.

Points-Of-Interest (POIs) may be verbally described to the user. For instance, voice explication (defined by user preference) may be implemented for POIs correlating to the map view. Once glance ahead is chosen from a suitable menu, voice explication preferably includes the exit name/number, then enumerating the POIs at the given exit.

The user directed search criteria for potential side trip POIs along a calculated route can be based on input including restaurant(s), mass transit station(s), shopping, hospital(s)s, park(s), fast food, any McDonalds™, any Walmart™, any antique store, any hotel around a given location such as the destination, etc.

The navigation server 130 formulates a query to the mapping database 150 based on the relevant search criteria implemented by the user.

The search criteria may be included in a routing request from the navigation system 100 of the wireless device 110. Based on the calculated route (or actual route as the route is being traversed), the mapping tiles for display are obtained from the mapping database 150.

The route of a particular navigation system 100 on a relevant wireless device 110 is maintained at the navigation server 130 when the route is active. The navigation system 100 may be identified by the navigation server 130 by reference to the mobile identification number (MIN) of the host wireless device 110. Persistent updates to side trip routing may be provided as the user traverses a route to a desired destination.

As the wireless device 110 traverses the formulated route that triggers wireless device 110 to transmit a request for mapping updates, POI(s) and side trip routing data for the POI(s) are continually updated along with updates to the routing information from the beginning geographic location and ending geographic location. Conventionally, mapping tiles are not displayed with POI criteria displayed thereon, with a user having to perform a separate POI search to display such information. However, in accordance with the principles disclosed herein, a request to upodate the location of a wireless device 110 or a mapping tile automatically triggers navigation server 130 to perform a search in a POI database 140 for a previously received search criteria that is associated with a particular MIN. The previously stored search criteria retrieved from POI database 140 is used to add POI icons related to the retrieved POI search criteria. The POI icons, side trip routing data for the POI(s), and location updates for the wireless device 110 are packaged for transmission to a requesting wireless device 110.

Mapping tiles, their associated icon(s) for POI, and side trip routing data for the POI(s), shown in more detail in FIG. (5A)-(5D), are transmitted to the wireless device 110. In this manner, a user must enter search criteria for a POI only once at the beginning of route guidance to an ending geographic location. During traversal of a route by wireless device 110, POI icon(s) and side trip routing data for the POI(s) are automatically updated without the user to stop and separately search for POI(s). This saves a user a substantial amount of time and frustration from having to back out of route guidance and enter search criteria for POI(s) during traversal of a route to the ending geographic location.

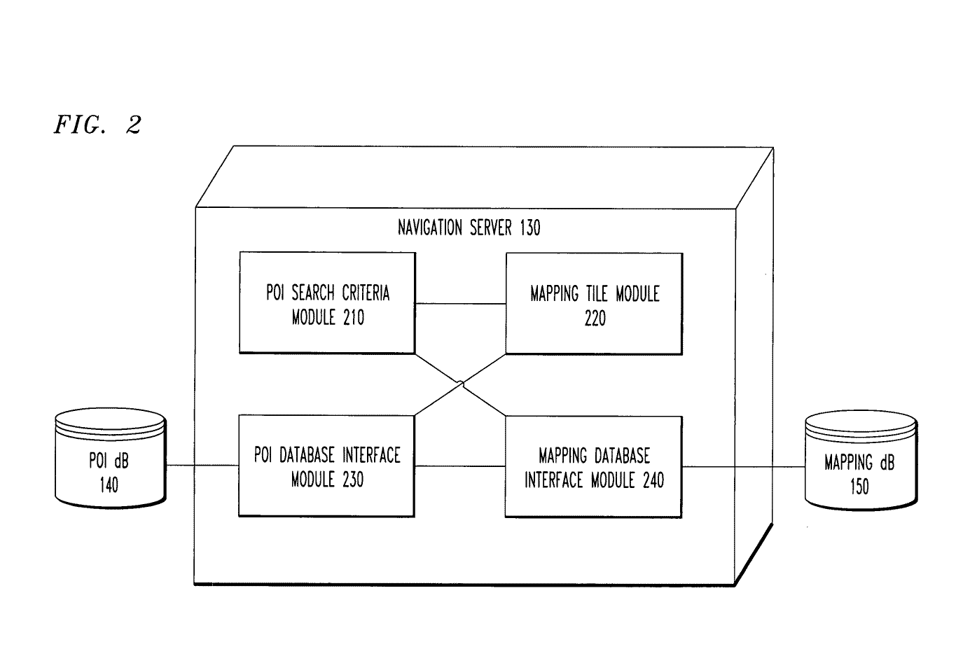

FIG. 2 illustrates a detailed view of a navigation server, in accordance with the principles of the present invention.

In particular, the navigation server 130 includes a POI search criteria module 210, a mapping tile module 220, a POI database interface module 230, and a mapping database interface module 240.

The POI search criteria module 210 communicates with a wireless device 110. The POI search criteria module 210 accepts a POI search criteria from a wireless device 110 and directs the POI search criteria be stored in association with a particular wireless device 110 for future reference in POI database 140. Upon navigation server 130 receiving a request for a mapping tile and/or an update to the location of the wireless device 110, the POI search criteria module 210 formulates a request for an appropriate previously stored POI search criteria. The previously stored POI search criteria is used to retrieve POI(s) that match the POI search criteria from the POI database 140 for a particular wireless device 110.

The mapping tile module 220 formulates a database query to retrieve appropriate mapping tiles from the mapping database 150. Moreover, the mapping tile module 220 formulates a database query to retrieve appropriate POI(s) from the POI database 140 based on the previously stored POI search criteria stored in the POI database 140 for a particular wireless device 110.

POI database interface module 230 provides an interface between the POI database 140 and the POI search criteria module 210. The POI database interface module 230 accepts a POI database 140 query from the POI search criteria module 210 and provide the appropriate low level data communications to pass the query to the POI database 140. Upon the POI database 140 finding an appropriate match in response to a database query, the POI database interface module 230 provides the appropriate low level data communications to allow the navigation server 130 to communicate with the POI database 140.

The mapping database interface module 240 provides an interface between the mapping database 150 and the mapping tile module 220. The mapping database interface module 240 can accept a mapping database 150 query from the mapping database interface module 240 and provide the appropriate low level data communications to pass the query to the mapping database 150. Upon the mapping database 150 finding an appropriate match in response to a database query, the mapping database interface module 240 provides the appropriate low level data communications to allow the navigation server 130 to communicate with the mapping database 150.

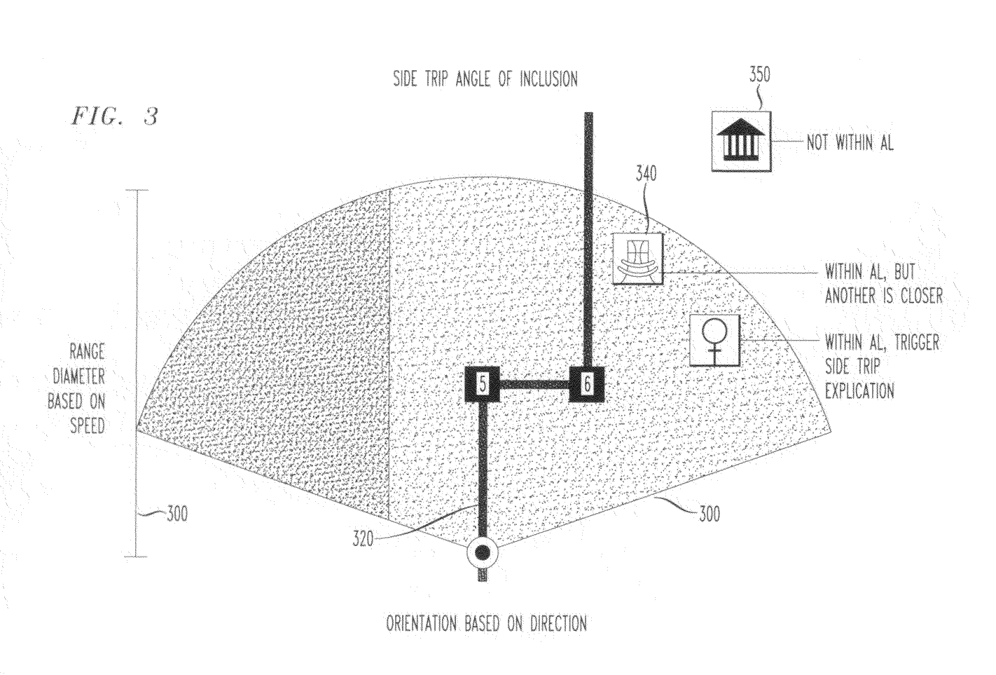

FIG. 3 illustrates a side trips angle of inclusion, in accordance with the principles of the present invention.

In particular, the side trip inclusion angle 300 includes a wireless device's 110 current geographic location 310 and a formulated route 320 from the current geographic location 310. Various POIs are shown that include a POI 330 that is within the side trip angle of inclusion 300, a POI 340 that is within the side trip angle of inclusion 300 but not closest to the wireless device's 110 current geographic location 310, and a POI 350 that falls outside of the side trip angle of inclusion 300.

Preferably, the width of the side trip angle of inclusion 300 is adjustable according to user preferences. Wireless device 110 can provide a preferences menu that allows a user to set the angle of the side trip angle of inclusion 300. A user that desires only POIs that are a short distance off of the formulated route 320 would set a smaller angle for the side trip angle of inclusion 300. In this manner, the physical area covered by the side trip angle of inclusion 300 is diminished and would reduce the number of POIs available for side trips. Likewise, a user that desires POIs that are a greater distance off of the formulated route 320 would set a larger angle for the side trip angle of inclusion 300. In this manner, the physical area covered by the side trip angle of inclusion 300 is increased and would increase the number of POIs available for side trips.

Preferably, the range diameter 360 of the side trip angle of inclusion 300 is based on a speed of the wireless device 110. As a speed of the wireless device 110 increases, the range diameter 360 would likewise increase. In this manner, the faster the speed of the wireless device 110 the greater the advance notice of POIs. Likewise, the slower the speed of the wireless device 110, the lesser the advance notice for POIs.

Preferably, the side trip inclusion angle 300 does not backtrack a wireless device 110 off of a formulated route 320, including only POIs that lie ahead on the projected path. If a user is so inclined, a user can set the angle of the side trip angle of inclusion 300 to allow for backtracking, with the user even being able to set the side trip angle of inclusion 300 to an extreme full circle of coverage.

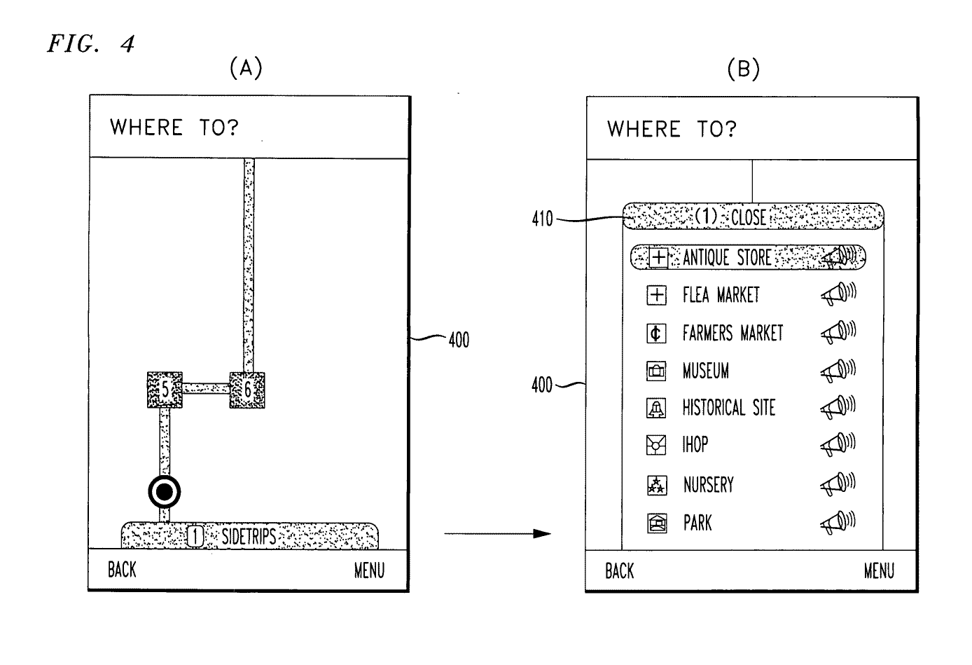

FIGS. 4(A) and 4(B) illustrate a selection of a user defined POI for side trips, in accordance with the principles of the present invention.

A user of a wireless device 110 can manage their side trips panel 400, adding and/or deleting POI(s) and categories via appropriate menu options 410. Selecting a POI in the side trips panel 400 and clicking an OK/Fire control toggles whether a POI will be treated as a side trip and explicated, if within an angle of inclusion 300.

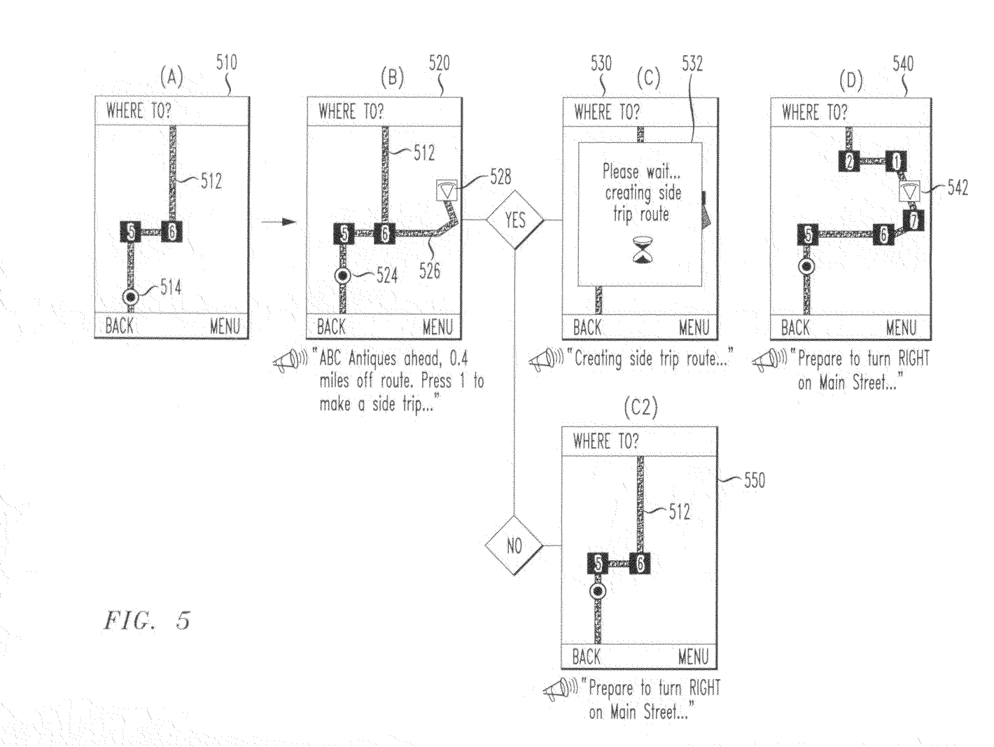

FIGS. 5(A)-5(D) illustrate selection of a side trip during guided navigation, in accordance with the principles of the present invention.

FIG. 5(A) shows a first GUI 510 illustrating a wireless device 110 at a first geographic location 514 along a guided route 512.

FIG. 5(B) shows a second GUI 520 illustrating a wireless device 110 at a second geographic location 524. A user defined POI 528 from a user defined list that has come within an angle of inclusion 300 become visible to a user of a wireless device 110. An optional side trip route 526 is further displayed for a user of a wireless device 110. With display of the second GUI 520, a user of a wireless device 110 can select to take the optional side trip route 526, which will result in side trips GUI 530 of FIG. 5(C-1) being displayed. Alternately, if a user of a wireless device 110 selects to continue along the guided route 512 a fifth GUI 550 is displayed on the wireless device 110. Preferably, performing no action infers that a user would like to continue on guided route 512.

FIG. 5(C-1) shows a third GUI 530 illustrating an announcement pane 532. Announcement pane 532 informs a user of a wireless device 110 that route guidance is being updated in response to a user selecting to take the optional side trip route 526. A message, such as “Please wait . . . creating side trip route” is displayed in the announcement pane 532.

FIG. 5(D) shows a fourth GUI 540 illustrating a calculated new guided route 542. The new guided route 542 now includes the user selected POI 528 as a stop over within the original guided route 512.

Depending upon device constraints of the wireless device 110, a user may speak a “Yes” command instead of using button (either a physical button or virtual screen button) to initiate commands associated with the side trips GUIs 510-550 disclosed herein. Alternately, a physical button or a virtual screen button can be used to initiate commands associated with the side trips GUIs 510-550 disclosed herein.

Once a user decides to navigate to a user defined POI 528, the original guided route 512 is modified to include the user defined POI 528. Preferably, functionality is suspended to avoid recursive “Side Trip from a Side Trip from a Side Trip” behavior.

Since there may be side trip explications one after another, preferably user action to take a side trip is put upon the user, and is thus much simpler and less cumbersome than conventionally having a user to take action and decline that action.

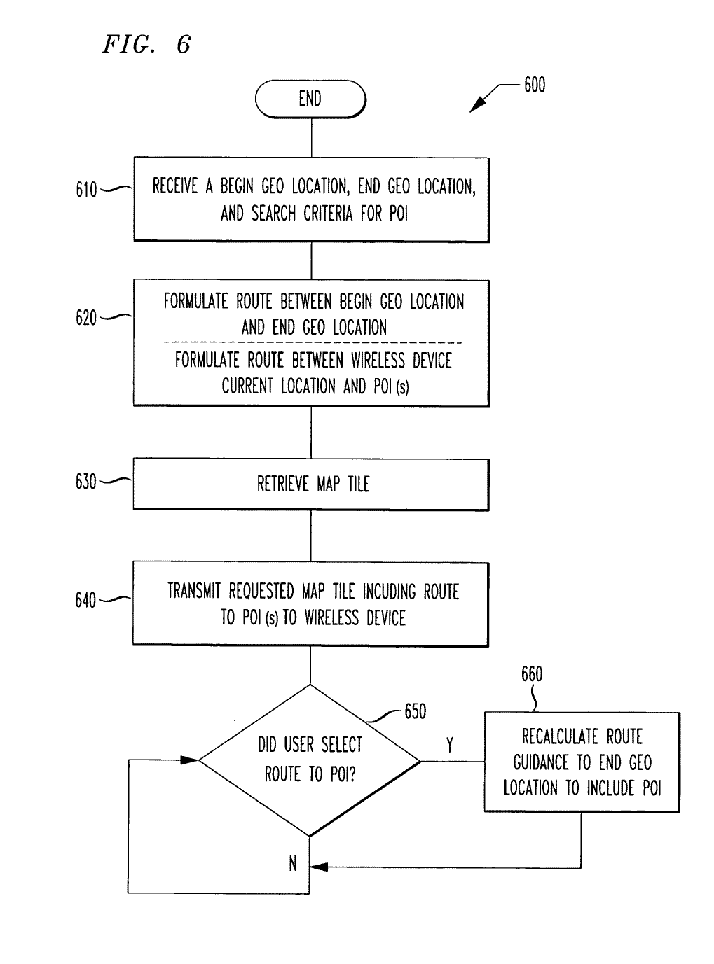

FIG. 6 illustrates a process 600 of route guidance to a POI, in accordance with the principles of the present invention.

In step 610, navigation server 130 receives a beginning geographic location, an ending geographic location, and search criteria for one or more POI. Wireless device 110, through an appropriate GUI, is provided with menu options to allows a user to enter the beginning geographic location, the ending geographic location, and the search criteria for one or more POI. One or more data packets with the user provided data is transmitted from wireless device 110 to navigation server 130.

In step 620, the beginning geographic location, the ending geographic location, and the search criteria for one or more POI received by navigation server 130 are used to formulate route guidance between geographic locations associated with such provided data. Route guidance is formulated between the beginning geographic location and the ending geographic location. Route guidance is formulated between the wireless device's 110 current location and one or more POI, as determined from positioning information provided by the wireless device 110 itself (e.g., based on GPS data) or from a mobile positioning center remote from the wireless device 110 (e.g., based on angle of arrival).

In step 630, the position of the wireless device 110, the beginning geographic location, the ending geographic location, and the location of one or more POI are used to retrieve a mapping tile from mapping database 150. Preferably, the mapping tile retrieved from the mapping database 150 allows a user to conveniently view all such information upon a single screen of the wireless device 110. Single screen viewing allows a user to make a decision as whether to stay on their primary route between the beginning geographic location and the ending geographic location, or whether to take a detoured route to the ending geographic location with a POI as a stopover geographic location.

In step 640, the mapping tile retrieved from step 630 is transmitted to the wireless device 110. The mapping tile including route guidance information between the beginning geographic location and the ending geographic location, and route guidance to one or more POIs, formulated in 620 and retrieved in step 630, are transmitted from the navigation server 130 to the wireless device 110. Navigation server 130 formulates one or more data packets including such information for transmission over wireless network 120.

In step 650, process 600 conditionally branches depending upon a user of the wireless device 110 selecting a route to a POI. If a user of the wireless device 110 selects to take a detour from their current location along a formulated route to their ending geographic location through a selected POI, process 600 branches to step 660. Otherwise, step 650 branches back to itself to continue to monitor for a user selection of a POI.

In step 660, the route formulated in step 620 is recalculated to include a user selected POI. The original route between the beginning geographic location and the ending geographic location is recalculated between a current geographic location of the wireless device and the ending geographic location to now include a user selected POI. The navigation server 130 receives a current location of a wireless device 110, a geographic location of a POI, and the ending geographic location. From these three geographic locations, the navigation server 130 formulates a route from the current location of the wireless device 110 to the ending geographic location, with the user selected POI as a stopover location along the newly formulated route.

As a parallel process (not shown) to process 600, a formulated route between the beginning geographic location and the ending geographic location is continuously updated to reflect the current location of the wireless device 110, as is known within the art.

While the exemplary embodiments disclosed herein illustrate a wireless device 110, one of ordinary skill in the art would appreciate that the teaching disclosed herein would apply to stand alone navigation devices. Such stand alone navigation devices include mapping data, POI data, and route guidance processing integrated therein. The processes disclosed herein being performed by navigation server 130 would thus be performed by such a stand alone navigation device.

While the invention has been described with reference to the exemplary embodiments thereof, those skilled in the art will be able to make various modifications to the described embodiments of the invention without departing from the true spirit and scope of the invention.

What is claimed is:

1. A navigation device, comprising:
a route determiner module to formulate a first route from a first geographic location to a second geographic location;
a route presentation module to present said first route to a user o said navigation device;
a side trip presentation module to present a point-of-interest to a user of said navigation device and to formulate a second route to said point-of-interest;
an options module to present an option, during said presentation of said first route, to said user of said navigation device to recalculate said first route to said second geographic location to comprise said second route.

2. The navigation device according to claim 1, wherein:
said side trip presentation module formulates said second route based on angle of inclusion between said navigation device and said point-of-interest.

3. The navigation device according to claim 1, wherein:
at least one of said first route and said second route are formulated from Global Positioning System (GPS) information.

3. The navigation device according to claim 1, wherein:
said navigation device is a cellular telephone.

4. The navigation device according to claim 1, wherein:
said point-of-interest is at least one of a restaurant, a shopping establishment, a historic building, and a park.

5. The navigation device according to claim 1, wherein:
a remote navigation server comprises said route determiner module.

6. The navigation device according to claim 1, wherein:
said side trip presentation module produces a visual representation of said point-of-interest.

7. The navigation device according to claim 1, wherein:
said side trip presentation module produces an audio representation of said point-of-interest.

8. A method of formulating side trips for a navigation device, comprising:
formulating, with a route determiner module, a first route from a first geographic location to a second geographic location;
presenting, with a route presentation module, said first route to a user of said navigation device;
presenting, with a side trip module, a point-of-interest to a user of said navigation device;
formulating, with said side trip module, a second route to said point-of-interest; and
providing an option, during said presentation of said first route with an options module, to said user of said navigation device to recalculate said first route to said second geographic location to comprise said second route during said presentation of said first route.

9. The method of formulating side trips for a navigation device according to claim 8, wherein:
said step of formulating a second route formulates said second route based on angle of inclusion between said navigation device and said point-of-interest.

10. The method of formulating side trips for a navigation device according to claim 8, wherein:
said step of formulating a first route formulates said first route based on Global Positioning System (GPS) information.

11. The method of formulating side trips for a navigation device according to claim 8, further comprising:
communicating, with a cellular front end, at least one of said first route and said point-of-interest over a cellular communications network.

12. The method of formulating side trips for a navigation device according to claim 8, further comprising:
said point-of-interest is at least one of a restaurant, a shopping establishment, a historic building, and a park.

13. The method of formulating side trips for a navigation device according to claim 8, further comprising:
communicating with a remote navigation server.

14. The method of formulating side trips for a navigation device according to claim 8, further comprising:
producing a visual representation of said point-of-interest.

15. The method of formulating side trips for a navigation device according to claim 8, further comprising:
producing an audio representation of said point-of-interest.

16. Apparatus for formulating side trips for a navigation device, comprising:
means for formulating a first route from a first geographic location to a second geographic location;
means for presenting said first route to a user of said navigation device;
means for presenting a point-of-interest to a user of said navigation device;
means for formulating a second route to said point-of-interest; and
means for providing an option, during said presentation of said first route, to said user of said navigation device to recalculate said first route to said second geographic location to comprise said second route.

17. The apparatus for formulating side trips for a navigation device according to claim 16, wherein:
said means for formulating a second route formulates said second route based on angle of inclusion between said navigation device and said point-of-interest.

18. The apparatus for formulating side trips for a navigation device according to claim 16, wherein:
said means for formulating a first route formulates said first route based on Global Positioning System (GPS) information.

19. The apparatus for formulating side trips for a navigation device according to claim 16, further comprising:
means for communicating at least one of said first route and said point-of-interest over a cellular communications network.

20. The apparatus for formulating side trips for a navigation device according to claim 16, further comprising:
said point-of-interest is at least one of a restaurant, a shopping establishment, a historic building, and a park.

21. The apparatus for formulating side trips for a navigation device according to claim 16, further comprising:
means for communicating with a remote navigation server.

22. The apparatus for formulating side trips for a navigation device according to claim 16, further comprising:
means for producing a visual representation of said point-of-interest.

23. The apparatus for formulating side trips for a navigation device according to claim 16, further comprising:
means for producing an audio representation of said point-of-interest.
